(19) United States
(12) Patent Application Publication
(10) Pub. No.: US 2013/0062950 A1
(43) Pub. Date: Mar. 14, 2013

(54) DEVICE FOR SUPPLYING AUXILIARY POWER TO AN ITEM OF EQUIPMENT ON A CURRENT-LIMITED POWER SUPPLY BUS

(71) Applicants: Nicolas Dangy-Caye, Rueil Malmaison (FR); Christel Prioleau, Rueil Malmaison (FR)

(72) Inventors: Nicolas Dangy-Caye, Rueil Malmaison (FR); Christel Prioleau, Rueil Malmaison (FR)

(73) Assignee: SAGEMCOM BROADBAND SAS, Rueil Malmaison (FR)

(21) Appl. No.: 13/699,584

(22) PCT Filed: May 23, 2011
(86) PCT No.: PCT/EP2011/058383

§ 371 Date: Nov. 21, 2012

(30) Foreign Application Priority Data
May 27, 2010 (FR) 1054063

(51) Int. Cl. G05F 5/00

(52) U.S. Cl. 307/64

(57) ABSTRACT

The power supply circuit for powering equipment via a current-limited power supply bus at a nominal voltage (Vb) of the equipment includes an auxiliary power supply circuit comprising an energy storage member and a trigger member for triggering auxiliary power supply to the equipment from the storage member via a voltage-reducing converter for reducing the auxiliary voltage to the nominal voltage.

The present invention relates to an auxiliary power supply circuit for powering equipment that is powered via a current-limited bus at a nominal voltage

### BACKGROUND OF THE INVENTION

It is known that host data processor machines, whether they are computers or communications platforms, generally include a voltage regulated power supply bus that is current limited, e.g. a universal serial bus (USB) having USB ports to which external pieces of equipment can be connected. Some such pieces of equipment, and in particular external hard disks, nevertheless give rise to a problem because of the particularly high current draw that the equipment generates when it starts.

The maximum authorized power available on a USB power supply bus (5 volts (V), 500 milliamps (mA)) is generally not sufficient to satisfy such equipment. The required power can then be obtained only by delivering current that is much greater than the maximum current authorized on a USB power supply bus.

To mitigate those insufficient levels of nominal power on a USE port, it is common practice to power external equipment via an independent external power supply circuit. Nevertheless, that solution is economically most disadvantageous because of the extra cost represented by the external power supply circuit both in terms of manufacturing costs and in terms of running costs. In addition, an external power supply circuit significantly increases the overall size of the equipment and complicates the wiring of the installation that includes that equipment. In order to mitigate the insufficient nominal power of a USB port, proposals have also been made to power external equipment via two USB ports, using a specific Y-cable. Nevertheless, that solution can be implemented only if the host machine has a number of USB ports that is sufficient to enable all of the external pieces of equipment to be connected thereto.

In order to mitigate the insufficient nominal power of a USB port, proposals have also been made to overdimension the power supply bus of the host machine. Under such circumstances, it is nevertheless necessary to overdimension all of the host machine, thereby giving rise to extra costs during fabrication of the host machine. Furthermore, that solution cannot be installed on an existing host machine.

### OBJECT OF THE INVENTION

An object of the invention is to enable equipment to be operated, in particular an external hard disk, even when the current-limited power supply bus is not capable of delivering sufficient current.

### BRIEF DESCRIPTION OF THE INVENTION

Starting from the observation, that already forms part of the invention, that in numerous circumstances the high demand for current is of short duration only when starting the equipment, the invention proposes a power supply circuit that includes not only the current limited power supply bus at a nominal voltage of the equipment, but also an auxiliary power supply circuit comprising an energy storage member storing energy at a voltage higher than the nominal voltage and associated with a voltage regulator at the nominal voltage, and a trigger member that releases the stored energy to the equipment in parallel on the power supply bus.

Thus, by using a storage member at a voltage higher than the nominal voltage it is possible to deliver suddenly the power needed for starting the equipment.

In an advantageous version of the invention, the trigger member is sensitive to the actual voltage of the power supply bus. Thus, advantage is taken of a drop in the actual voltage of the power supply bus at the time the hard disk starts for automatically synchronizing a need for additional current with the triggering of the auxiliary power supply.

In another advantageous aspect of the invention, the storage member is powered by a voltage-multiplier circuit connected to the power supply bus. It is thus possible to charge the electricity storage member without having recourse to any external power supply.

### BRIEF DESCRIPTION OF THE DRAWINGS

Other characteristics and advantages of the invention appear on reading the following description of various embodiments of the invention given with reference to the accompanying figures, in which:

FIG. 1 is a diagram of a first embodiment of the power supply circuit of the invention;

FIG. 2 is a diagram of a power supply circuit analogous to that of FIG. 1 and also fitted with a timer member for triggering the auxiliary power supply;

FIG. 3 is a diagram of a variant embodiment of the FIG. 1 power supply circuit that is fitted with a timer member for triggering the auxiliary power supply;

FIG. 4 is a diagram of a power supply circuit analogous to that of FIG. 3 that is fitted with a variant timer member;

FIG. 5 is a diagram of a circuit analogous to that of FIG. 4 that is fitted with a circuit for providing protection against current overloads;

FIG. 6 is a diagram of another variant embodiment of the FIG. 1 circuit;

FIG. 7 is a diagram of a variant of the FIG. 2 circuit; and

FIG. 8 is a diagram of a power supply circuit of the invention in which the storage member is powered by a voltage-multiplier circuit connected to the power supply bus.

### DETAILED DESCRIPTION OF THE INVENTION

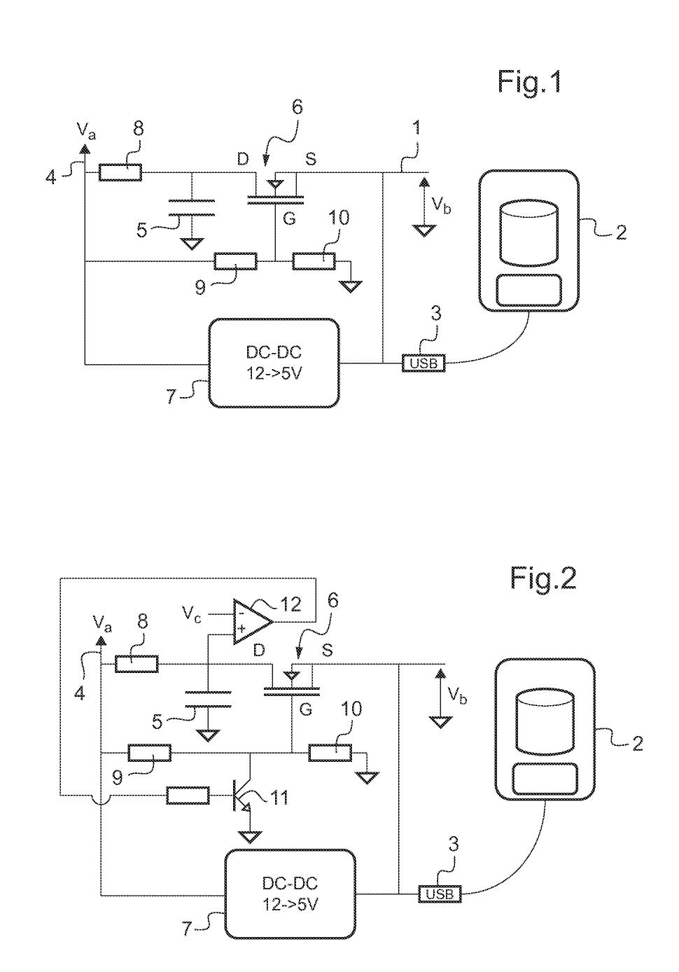

FIG. 1 shows a first embodiment in which the power supply circuit of the invention is incorporated in a host machine having a power supply bus 1 with a nominal voltage Vb for equipment 2 that is to be powered: in this example an external hard disk connected to a USB port 3 of the host machine. The power supply bus 1 is based on voltage/voltage conversion 7 and it is current-limited.

This first embodiment of the power supply circuit of the invention is incorporated in a host machine that also has a voltage-regulated power supply line 4 delivering an auxiliary voltage Va higher than the voltage of the power supply bus. Typically, the current-limited power supply bus is a USB bus having a voltage of 5 V, while the auxiliary voltage is 12 V.

The power supply circuit includes an energy storage member 5 that is connected to the power supply line 4 via a load resistor 8. The energy storage member 5 is associated with a voltage regulator 7 delivering a voltage at the nominal voltage Vb, and with a trigger member 6 constituting the auxiliary power supply of the equipment 1.

In the embodiment shown in FIG. 1, the energy storage member 5 is a capacitor having one terminal connected to ground and an opposite terminal connected to the drain of a negative-channel metal oxide semiconductor (nMOS) transistor forming the trigger member 6. The transistor 6 also has its source connected to the USB bus 1 and its grid associated with resistors 9 and 10 connected as a bridge across the auxiliary power supply line 4 so that the grid/source potential difference of the MOS transistor 6 is equal to or greater than a threshold voltage of the transistor 6 at which the transistor 6 is conductive when the actual voltage on the power supply bus 1 is less than or equal to a help voltage Vh at which the auxiliary power supply needs to be triggered.

When the host machine is switched on, the transistor 6 is non-conductive and the capacitor 5 charges until it reaches a target voltage equal to the auxiliary voltage Va.

When the USB port 3 is connected to equipment that on starting consumes current greater than the current that the USB power supply bus can deliver (such as an external hard disk), then the resulting current draw causes the power supply voltage Vb to drop. When this power supply voltage reaches the value of the help voltage Vh, the transistor 6 becomes conductive and the capacitor 5 discharges into the circuit, thereby delivering auxiliary power supply current in addition to the current delivered by the converter 7, and thus enabling the voltage on the USB power supply bus to rise. The auxiliary current is delivered by the storage member for a short period of time only, beyond which the equipment is assumed to be capable of operating with current that is low enough for the equipment to be capable of being powered solely by the USB power supply bus. Typically, the auxiliary current presents a peak of about 4 amps (A) at the moment the equipment is connected, immediately followed by a plateau of 2 A for about 150 microseconds (μs), with the nominal operating current thereafter being only 400 mA.

It should be observed that in this embodiment, it is necessary to switch on the host machine before connecting the external equipment. If the host machine is switched on while the external equipment is already connected, then the transistor 6 becomes conductive before the capacitor 5 has had time to charge.

FIG. 2 shows a power supply circuit analogous to that of FIG. 1, but also fitted with a timer member for timing triggering of the auxiliary power supply. In FIG. 2, components that are identical to those in the power supply circuit of FIG. 1 are given the same numerical references.

In the embodiment shown in FIG. 2, the timer member comprises a negative-positive-negative (npn) transistor 11 having its emitter connected to ground, its collector connected to the grid of the MOS transistor 6 at an intermediate point between the resistors 9 and 10, and its base is connected via a resistor to the output of a comparator 12 having an inverting input maintained at a target voltage Vc and a non-inverting input connected to the capacitor 5 in order to measure its instantaneous voltage. Thus, so long as the instantaneous voltage of the capacitor 5 is lower than the target voltage, the transistor 11 is conductive and the grid of the MOS transistor 6 is held at zero so that the MOS transistor is not conductive. The capacitor 5 charges progressively. When the instantaneous voltage of the capacitor 5 reaches the target voltage, the transistor 11 is switched off and the auxiliary power supply circuit then operates as described with reference to FIG. 1.

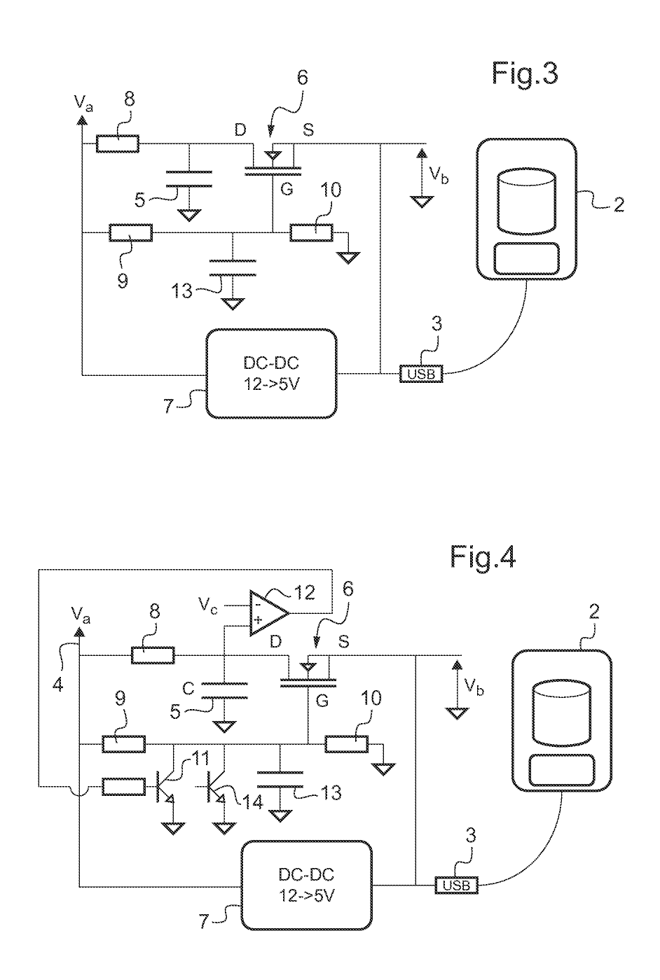

FIG. 3 shows a variant embodiment of the FIG. 2 circuit. As above, components that are identical with the above-described embodiments are given the same numerical references. In this embodiment, the transistor 11 and the comparator 12 are replaced merely by a capacitor 13 having one terminal connected to ground and an opposite terminal connected to the grid of the transistor 6 at an intermediate point between the resistors 9 and 10.

Nevertheless, it should be observed that on starting the empty capacitor of the circuit represents an additional load. FIG. 4 shows a power supply circuit analogous to that of FIG. 3, but further including a comparator circuit comprising a transistor 11 and a comparator 12 as in the embodiment of FIG. 2, and another npn transistor 14 having its emitter connected to ground, its collector connected to the grid of the transistor 6, and its base initially receiving a voltage that makes it conductive, and subsequently receiving a voltage that makes it non-conductive.

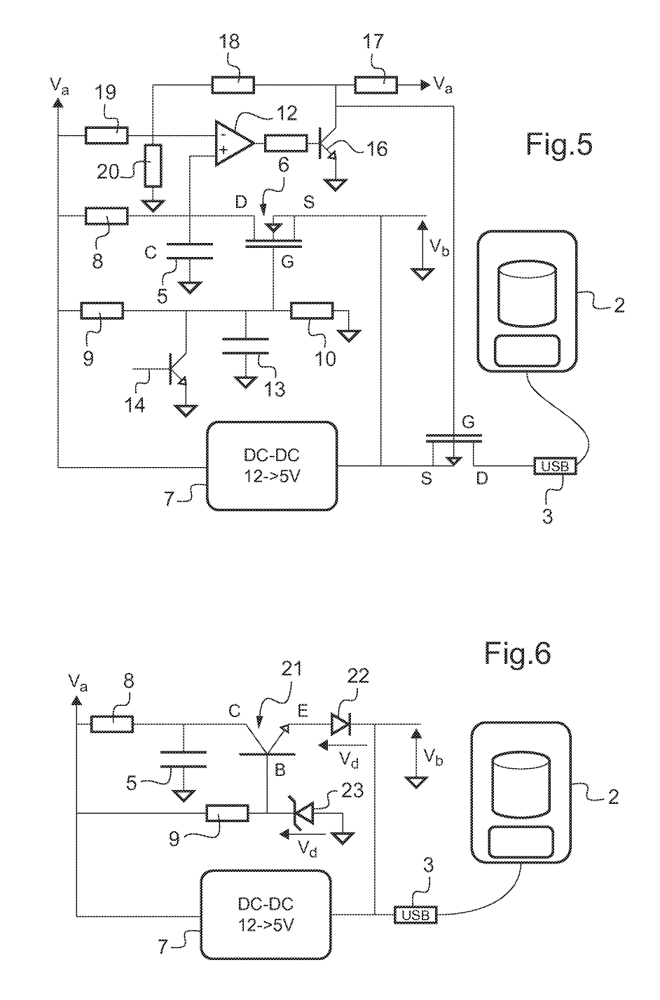

FIG. 5 shows a circuit analogous to that of FIG. 4, including a circuit for providing protection against current overloads. For this purpose, the power supply circuit includes a pMOS transistor 15 having its drain/source junction connected in series in the outlet line including the USB port 3, and having its grid connected to the collector of an npn transistor 16 having its emitter connected to ground and its base connected to the output of the comparator 12 via a resistor. The inverting input of the comparator 12 and the collector of the transistor 16 are connected to a resistor bridge 17 to 19 that sets the target voltage Vc.

During initial charging, the transistor 15 is switched off until the capacitor 5 has reached the target voltage Vc. No current can flow to any external equipment that might be connected to the USB port 3. When the target voltage has been reached, the MOS transistor 15 becomes conductive and allows current to flow to equipment 2 connected to the USB port 3. So long as the voltage of the capacitor 5 does not drop below a critical voltage Vcc defined by the resistors 17, 18, and 19, current can flow towards the equipment. In the event of an overload, e.g. in the event of a short circuit, the capacitor 5 discharges to a critical voltage at which the pMOS transistor 15 becomes non-conductive, such that the system is isolated from the overload created by the short circuit. When isolated in this way, the capacitor 5 charges and the cycle repeats so long as the short circuit is present.

In the above embodiments, one of the operating parameters of the power supply circuit is the threshold voltage of the MOS transistor. This threshold voltage may vary as a function of the process used for fabricating the transistor. This variation in threshold voltage may be troublesome in certain circumstances.

FIG. 6 shows a variant embodiment of the power supply circuit of the invention in which the MOS transistor of the first embodiment is replaced by an npn transistor 21 having its emitter connected to a Schottky diode 22, the resistor 10 also being replaced by a zener diode 23 connected firstly to ground and secondly to the base of the transistor 21. The voltage at the base of the npn transistor 21 is equal to the voltage Vz imposed by the zener diode. There is thus a reference voltage on the base of the transistor 21. This reference voltage is set as a function of the help voltage that it is desired to obtain, of the voltage Vd of the Schottky diode, and of the voltage Vbe of the base/emitter junction of the transistor 21. When the voltage of the power supply bus is greater than the help voltage, then:

Vbe+Vd<0.65

The transistor 21 is not conductive. No current can flow from the capacitor to the external equipment. In contrast, when the voltage of the USB bus is less than the help voltage, the base/emitter junction voltage of the transistor 21 is greater than 0.65 V, and the transistor 21 is conductive. Current can then flow from the capacitor 5 to the equipment 2.

Compared with the embodiments described above, it will nevertheless be observed that this embodiment presents the drawback of power being lost in the Schottky diode.

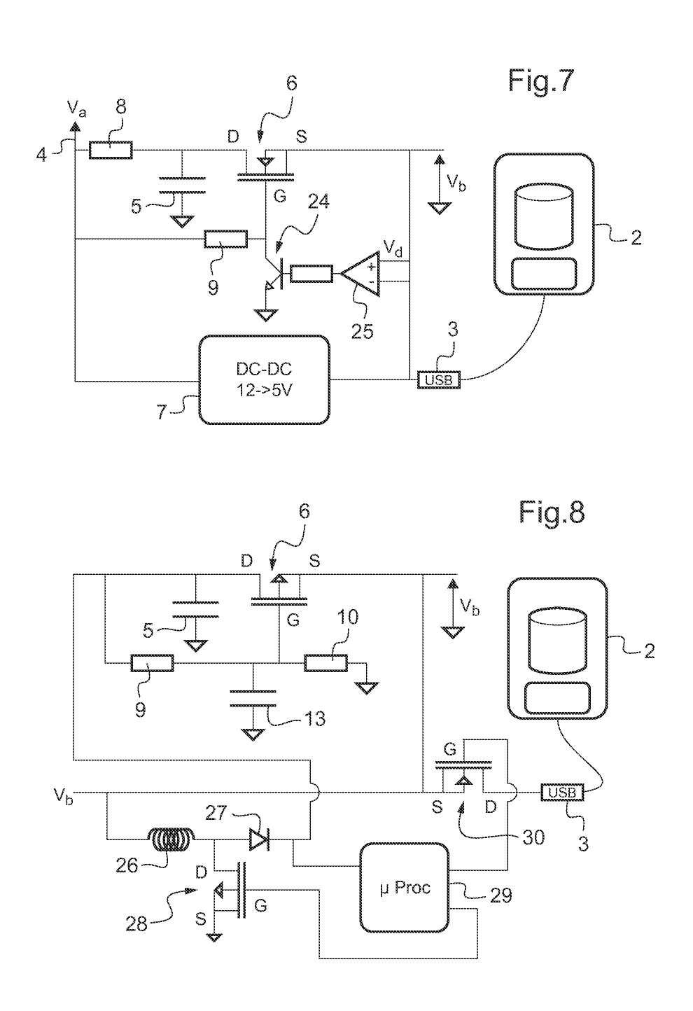

FIG. 7 shows a variant embodiment capable of eliminating the consequences of variation in the voltage threshold of a MOS transistor. Starting from the circuit described with reference to FIG. 1, the resistor 10 is replaced by an npn transistor 24 having its collector connected to the grid of the MOS transistor 6, its emitter connected to ground, and its base connected to the output of the comparator 25 via a resistor, the non-inverting input of the comparator being connected to the source of the MOS transistor 6 and its inverting input receiving a voltage representative of the help voltage Vh.

The voltage comparator 25 serves to control the availability of the auxiliary power stored in the capacitor 5.

If the voltage of the power supply bus drops below the help voltage, the output of the comparator 25 changes over and serves to control the voltage at the grid of the transistor 6 so that the transistor 6 conducts. When the external equipment no longer needs additional energy, the instantaneous voltage of the bus returns to its nominal value, i.e. a value greater than the help voltage, such that the comparator changes state and causes the MOS transistor 6 to be non-conductive once more. The comparator 25 thus serves to avoid the problem of uncertainty concerning the threshold voltage of the MOS transistor 6. Nevertheless, this solution is more expensive and it should be selected only when circumstances make that necessary.

When the host machine does not have a power supply at a voltage greater than the nominal voltage of the equipment, the invention makes provision for a voltage-multiplier circuit that is connected to the power supply bus. The power supply circuit preferably includes means not only for initially charging the capacitor 5, but also for maintaining this charge in order to compensate for leakage currents.

An embodiment of the voltage-multiplier circuit is shown in FIG. 8 with reference to a power supply circuit in accordance with the invention shown in FIG. 3.

Starting from the circuit of FIG. 3, the converter 7 is replaced by a voltage-multiplier stage having an inductor 26 with one terminal connected to the USB power supply bus and an opposite terminal connected firstly to the input of a diode 27 and secondly to the drain of a pMOS transistor 28 having its source connected to ground and its grid connected to a microcontroller 29. The output of the diode 27 is connected firstly to the high voltage terminal of the capacitor 5 and secondly to an input of the microcontroller 29. The microcontroller 29 is also connected to the grid of an nMOS transistor 30 having its source/drain junction connected in series with the USB port 3 in the USB power supply bus. The MOS transistor 30 serves to isolate the external equipment so long as the capacitor 5 is not charged.

It should be observed that the cost of the voltage-multiplier stage may be particularly low insofar as it is not essential for the charging time of the capacitor 5 to be fast. Thus, a gentle voltage-multiplying slope makes it possible advantageously to dimension the inductor 26, the diode 27, and the transistor 28 so as to provide a voltage-multiplier circuit at low cost.

Naturally, the invention is not limited to the embodiments described and may be modified by the person skilled in the art within the ambit of the invention as defined by the claims.

In particular, although FIG. 4 shows the use of a comparator 12 in association with the embodiment of FIG. 3, such an application may also be implemented in association with the power supply circuit as shown in FIG. 1.

The same applies for the use of a voltage-multiplier stage as shown in FIG. 8.

The invention is not limited to USB external hard disks; it may be extended and applied equally well to other types of external element insertion in a host machine. Another example is inserting electronic equipment in a small form-factor pluggable (SFP) cage.

What is claimed is:

1. A power supply circuit for powering equipment via a current-limited power supply bus at a nominal voltage (Vb) for the equipment, wherein the power supply circuit includes an auxiliary power supply circuit comprising an energy storage member for storing energy at a voltage (Va) higher than the nominal voltage (Vb) and associated with a voltage regulator, and a trigger member for releasing the stored energy to the equipment in parallel with the power supply bus, the storage member being a capacitor and the power supply circuit including a timer member for delaying triggering of the auxiliary power supply.

2. The circuit according to claim 1, wherein the trigger member is sensitive to the actual voltage of the power supply bus.

3. The circuit according to claim 1, wherein the storage member is powered by a voltage-multiplier circuit connected to the power supply bus.

4. The circuit according to claim 2, wherein the timer member includes a comparator for comparing an instantaneous voltage of the storage member with a target voltage.

5. The circuit according to claim 2, wherein the capacitor forming the storage member is associated with a MOS transistor having a grid voltage set by a resistor bridge so that a grid/source potential difference of the MOS transistor is equal to or greater than a threshold voltage of the MOS transistor so long as the actual voltage of the power supply bus is less than or equal to a help voltage (Vh) at which the auxiliary power supply is triggered.

6. The circuit according to claim 5, wherein the timer member is a blocking transistor serving to keep the grid voltage of the MOS transistor at zero for a length of time sufficient for charging the storage member.

7. The circuit according to claim 6, wherein the blocking transistor has a base connected to the output of a comparator for comparing the target voltage with an actual voltage of the storage member.

8. The circuit according to claim 5, wherein the timer member is a capacitor connected between an intermediate point of the resistor bridge and ground of the circuit.

9. The circuit according to claim 1, including a member for limiting current through the auxiliary power supply circuit.
